(19) United States
(12) Patent Application Publication
(10) Pub. No.: US 2004/0091678 A1
(43) Pub. Date: May 13, 2004

(54) Universal cover

(76) Inventor: James Lowell Jordan, Riverside, CA (US)

Correspondence Address: James Lowell Jordan, 1971 Camden Street, Riverside, CA, 92506, US

(21) Appl. No.: 10/291,277

(22) Filed: Nov. 12, 2002

(51) Int. Cl. B32B 3/00

(52) U.S. Cl. 428/192

(57) ABSTRACT

A universal cover whose edges are metallic foil and polymeric laminate, held together by heat sealing and/or adhesive, or any other method to attach them, so that one or both surfaces of the laminate is/are metallic foil. Metallic foil in the rim can be on one side, the other surface being polymeric film. Metallic foil can be on both sides, the polymeric film being between the two metallic foils. The can be used home, clinical, industrial, and settings. In clinical settings, such as as a stethoscope head cover, the internal membrane would be thin enough and deformable as not to interfere with sound collection and transmission; the deformability and holdability of the outside rim/edge would make it easy to apply and remove. The ease of transmission of sound through the thin membrane also makes it usable for cellular telephones, microphones, pagers, and other such sound transmission/receiving devises. When used for firearms, as a light cover for the muzzle of a weapon, the internal membrane can be thin enough and deformable to prevent contamination of the barrel, but thin enough not to interfere with projectile performance; the deformability and holdability of the outside rim would make it easy to apply and remove. When used to cover containers in a clinical, construction, business, or laboratory setting, the internal membrane can be inert enough not to react with the contents being covered, but the deformability of the outside rim/edge makes it easy to apply and remove. When used in field settings, for military or outdoor activities, the invention would be inexpensive, disposable, effective, and light.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to a universal cover, constructed from a polymeric film membrane with an deformable metallic foil-polymeric film rim (edge), for use as a barrier over surfaces and the openings of containers and tubing.

2. Background of the Invention

### Covers in General

Using covers for containers and surfaces has been practiced from prehistory. Over time, as materials and methods have advanced, so have covers. Covers are now made out of a wide variety of materials, albeit progress is still being made in their development. Covers, of course, have the following functions: keep the covered item from losing its contents, keep external contaminants from affecting the covered item, and/or prevent the transference of a contaminant (or pathogen) from one surface to another. When used in a clinical setting, the intent may be to prevent pathogen spread, either in the covered item or from locality to locality. In other settings, such as muzzles of firearms, a cover may be used to keep contaminants out of the barrel since they may cause failure or destruction of the weapon, and possibly, injury to the shooter. Covers are often as needed from metallic foils and/or polymeric films. The latter is particularly important in food storage.

### Metallic Foils and Polymeric Films

The universal cover utilizes the advantages of metallic foil, polymeric film, and metallic foil—polymeric film laminate for a cover. Metallic foils and polymeric films are often used to form covers, often of a temporary and disposable nature. A primary use of polymeric films and laminates containing polymeric layers has been to cover and package foods to reduce gaseous exchange and vapor transmission (U.S. Pat. Nos. 3,931,449, 3,932,692, 3,932,693, 3,949,114, 4,003,963, 4,064,296, 4,082,854, 4,194,039, 4,240,993, 4,355,721, 4,568,580, 4,612,221, 4,959,271, 4,977,004, 5,119,940, 5,256,428, 5,310,587, 5,405,629, 5,439,132, 6,183,791). Since the use of monolayer materials did not always have the characteristics desirable for some purposes, multilayer polymeric films have been developed having properties that are different characteristics from the individual polymeric films. Knott II et al. (U.S. Pat. No. 4,355,721) noted this when they wrote “the sheet or film is a multilayer construction wherein each layer performs specific functions and the choice of materials for the layers is independent to provide a film structure having all desired properties at the least cost.” The benefits of multilayer polymeric laminates was also noted in U.S. Pat. No. 4,194,039; that patent was for a multilayer polyolefin shrink film that had more desirable “shrink tensions, optical clarity, cuttability, sealability, shrink temperature range, and tear resistance heretofore unobtainable in an oriented, monolayer polyolefin material.” A similar claim was made in U.S. Pat. No. 4,239,826 in which a multilayer film comprised of a core layer of vinyl alcohol polymers and one or more external layers of a partially hydrolyzed vinyl acetate polymer. The inventors claimed that “the core layer provides an excellent oxygen barrier, while the adjacent layers protect the core layer from degradation by exposure to water vapor.” Other U.S. patents which note a number of enhanced qualities of multilayer films over monolayer films are U.S. Pat. No. 4,240,993 (heat shrinkable film), U.S. Pat. No. 4,254,169 (three layer laminate as in U.S. Pat. No. 4,239,826), U.S. Pat. No. 4,355,721 (heat sealable food packaging), U.S. Pat. No. 4,381,380 (thermoplastic treated with iodine for antibacterial use), U.S. Pat. No. 4,568,580 (improved resistance to heat treatment), U.S. Pat. No. 4,578,294 (improved resistance to heat treatment), U.S. Pat. No. 4,612,221 (improved dinginess; resistance to heat; low permeability to oxygen, moisture and odor), U.S. Pat. No. 4,617,241 (“improved combination of elongation, elastic memory, tear resistance and heat shrinkability), U.S. Pat. No. 4,801,486 (“superior cold strength”), U.S. Pat. No. 4,881,277 (increased puncture resistance of medical gloves), U.S. Pat. No. 4,901,372 (increased barrier protection against contamination), U.S. Pat. Nos. 4,930,522 and 5,024,852 (ability to seal pharmacologically active agents between the layers), U.S. Pat. Nos. 4,935,260 and 5,045,341 (encasement of therapeutic agents to kill pathogens), U.S. Pat. No. 4,959,271 (improved water vapor and gas barrier characteristics), U.S. Pat. No. 4,877,004 (reduced flavor loss of food, increased solvent barrier, protection from moisture and outside atmosphere), U.S. Pat. No. 4,977,022 (increased heat sealability with stretchability), U.S. Pat. No. 5,031,245 (increased antimicrobial capability), U.S. Pat. Nos. 5,090,406, 5,106,362 and 5,465,735 (better control of leakage of fluid from a wound), U.S. Pat. No. 5,256,428 (puncture resistance and heat shrinkability), U.S. Pat. No. 5,310,587 (microwavability and improved heat insulation), U.S. Pat. No. 5,397,513 (high shrink and puncture resistance properties), U.S. Pat. No. 5,707,751 (“improved shrink range, optics, toughness”), and U.S. Pat. No. 6,171,681 (improved dinginess with reusability). Many of the advantages of metallic foil, polymeric film, and metallic foil-polymeric film laminate would be present in the universal cover.

Because the universal cover uses a laminate, it also would have characteristics of a laminate. Previous attempts have been made to control oxygen permeability via laminates. According to Viola et al (U.S. Pat. No. 3,949,114) pinholes in polymeric laminates “cause serious increase in oxygen permeability. This tendency can be controlled to a useful degree by sandwiching the metallic foil foil between two biaxially oriented films which are identical or have very similar physical characteristics, so as to produce a balanced laminate.” That metallic foil can be a surface by itself in the laminate was not addressed. Moreover, since two polymeric films were being used, the resulting laminate had “a serious limitation on the grounds of convenience and cost in preparation of the laminates.” The cost factor would dramatically decrease if one, not two polymeric films were used to make the laminate. Stillman (U.S. Pat. No. 4,096,309) also utilized a multi-layer approach to making polymeric/metallic laminates. In his patent, the three layers comprised of “a flexible laminated packaging material comprising: (a) a non-woven sheet of spun-bonded polymeric filament; (b) a metallic foil affixed to said non-woven sheet; (c) an inner surface ply of heat-sealable polyolefin affixed to said metal foil; and, (d) a biaxially-oriented film affixed to and between said non-woven sheet and said metallic foil.” He claimed in his patent that the result was a “self-sealing, packaging laminate of extremely high strength and capacity.” He also claimed that his invention had the “provision of the various layers of the packaging laminate in a sequence which provides maximum inter-layer cooperation and simplifies manufacture. A particular object of this invention is the provision of a flexible, laminate material which can be self-sealed into pouches, bags and like packaging containers which are collapsible and so may be easily transported when empty while being capable of retaining contents of high weight and volume.” As noted, his patent was for a laminate containing two layers of polymeric material and an inner core of metallic foil. My invention has the polymeric and metallic layers both on opposite sides of the laminate. Thus, the advantages of the laminate and the polymeric film in the universal cover are beneficial.

Again, use of multilayered polymerics, as can be used in the universal cover, confers many advantages. Nakashio et al (U.S. Pat. No. 3,997,703) also addressed the use of multilayered plastics of pullulan and polymers, also in conjunction with paper or metallic foil, to reduce gas exchange of molded plastic. At least one of the layer in their invention contained pullulan. They also noted that the use of laminates (all containing pullulan) were particularly well suited for foodstuffs in that the laminate was “particularly excellent in barriering property against oxygen, nitrogen, carbon dioxide and steam.” When they sought to make inates containing “high molecular weight compounds relatively low in gas permeability such as . . . cellophane, . . . aluminum foils, or . . . polyvinyl compounds . . . ,” they encountered problems “such as being expensive, difficulty subjected to lamination molding, or give molded articles extremely high in cost.” Since then, however, additional polymerics and adhesives have been developed. Consequently, in terms of volume, polymerics are currently the most widely used materials in manufacture. The universal cover uses such polymerics and, thus, are amenable to being manufactured.

Adhesives can be incorporated into the universal cover to help improve its barrier properties. One attempt to improve the barrier qualities of polymeric materials and laminates has been through the use of adhesives either to form the laminate itself (as discussed earlier) or a web matrix (U.S. Pat. No. 4,055,698). A benefit of making a web, particularly one that constituted remoistenable ribbons (U.S. Pat. No. 4,055,698) was the reusability of the product. Both the use of webbing and adhesives can be used with a universal cover.

Also, in each of the aforementioned use of laminates, metallic foils, and polymeric films, the layers were consistent throughout the invention. In no case, did an invention concern a laminate and a polymeric film in separate regions of the invention. Thus, the separate regions, as found in the universal cover, have not been covered in previous patents.

### Lids and Covers from Metallic Foils and Polymeric Materials—Modifying the Container

The universal cover can be used to cover containers modified for specific covers. Sometimes the container itself is modified to better accommodate a film cover. Gorlich (U.S. Pat. No. 5,439,132) modified a tray to have “a peripheral flange with one or more raised ledges to secure a pair of membranes to enclose the tray.” Rather than have the two membranes as a laminate, they were kept separate. As a result, the outermost layer could be peeled off by the retailer of a food product, while the innermost would bear a label. That the cover itself could be adapted to a container, without changing the container, by the use of a deformable edge (rim) has not been patented. In U.S. Pat. No. 4,847,050, a resealable lid structure was designed for a container. The lid was secured by a preformed flange which surrounded a receptacle's periphery. In another patent (U.S. Pat. No. 5,119,940) a tray with a stiff collar completely encircling the tray and turned downward (and inward) was covered with a flexible transparent film. Kocher et al (U.S. Pat. No. 5,779,050) also devised a package that was modified to receive a polymeric film cover; partially the modification was the development of a lid that was “partially heat-shrinkable and has a first peripheral portion and a second peripheral portion.” Yet, the very process of having to modify the container, so that it can be sealed, increases the overall cost. Moreover, having a cover suitable for a specific container, so modified for it, means that users of such containers may have to have a sizeable inventory just to match needs. Such indicates a need for universal covers, since it can cover a wide variety of containers, including modified ones.

This invention, the universal cover, has the capacity of being used even on containers with modified lips (peripheries). That a impromptu flange can be formed to attach a cover to a container is routinely done when metallic foils are used; that use is one of the major benefits to using metallic foils in many situations. Polymeric materials, such as polyethylene and saran, can also be used to make covers for containers as well as protect surfaces. Their role as barriers was discussed previously. The universal cover efficiently and effectively utilizes those barrier properties.

This invention, the universal cover, also has the capacity to be used to serve as a cover when the item being covered cannot be modified. Examples include laboratory glassware, firearm muzzles, clinical equipment, and containers already in a person's/organization's possession. Thus, the universal cover has great utility as a cover for both modified and nonmodified items.

### Covers to Protect Surfaces

The universal cover can be used to help protect sheets. Plastics sheets and glass windows are susceptible to scratching and/or contamination with dirt, stains, or other. Consequently, polymeric materials have been used to form protective coverings for them. Woodside et al, (U.S. Pat. No. 6,089,300) designed “protective coverings . . . for glass windows and the like. The protective coverings comprise impact and puncture resistant protective panels formed from strand material which includes reinforcing fibers and polymeric material.” Universal covers could also be used to provide such surface protection.

### Covers to Protect Electronic Devices and Circuit Boards

The universal cover can be used to protect electronic devices and circuit boards. If dust or other contaminants settle upon a circuit board, the unit can short circuit when used. Consequently, Chung (U.S. Pat. No. 6,432,253) developed a cover (package) with an adhesive closer to protect electronic components. However, because adhesive was used, the covers are not readily reusable. A universal cover with polymeric film, treated to reduce the risk of static electric damage and insulated, would serve as a temporary, yet often reusable cover for electrically sensitive devices.

### Covers to Prevent Spread of Pathogens—Covers as Barriers

The universal cover can be used in situations requiring an impermeable barrier to help prevent the spread of pathogens. That impermeable barriers are useful in helping prevent the transmission of pathogens is well established in the literature. For that reason, health care professionals use gloves, cover surfaces, and wear masks and/or face protectors. Robinson developed an attachable thin film prophylactic barrier. He stated his patent was “a disposable, general purpose, protective, prophylactic barrier to aid in preventing cross-contamination from one operation to another. This prophylactic barrier, a visually transparent or translucent, flexible, pliable, planar, rectangular, thin-film, plastic sheet, provided with a coating of a low-tack pressure sensitive adhesive over a select adhesive area.” That the edge of the cover could serve to hold the barrier in place has yet to be covered in a patent. As a result, the universal cover, as in this invention, would be useful in help preventing the spread of pathogens.

### Covers to Prevent Spread of Pathogens—Changing the Polymeric Itself

The universal cover can be made with polymeric materials that are specifically designed to help prevent the spread of pathogens. Mochizuki et al (U.S. Pat. No. 4,675,347) and Milner (U.S. Pat. No. 5,031,245) utilized a cationic antimicrobial agent which was incorporated into an latex composition. Lorenz et al (U.S. Pat. No. 4,769,013) invented “a medical material comprising a polyurethane complexed with polyvinylpyrrolidone and a bio-effecting agent, such as an antibacterial agent, complexed with the polyvinylpyrrolidone.” Stockum (U.S. Pat. No. 4,853,978) further developed the antimicrobial characteristics of an item made from an elastomeric substance; he patented “an antimicrobial medical glove consisting essentially of an outer elastomeric body in the shape of a hand and an inner coating consisting an antimicrobial agent, said inner coating being capable of slowly releasing said antimicrobial agent in an amount and over a period of time sufficient to maintain an essentially bacteria-free and fungus-free environment within said glove after said glove has been donned.” Allen (U.S. Pat. No. 4,867,968) addressed pathogen transmission through the development of an elastomeric composition of “rubber latex and a masterbatch comprising a therapeutic agent effective amount, a carrier component, titanium dioxide, and clay.” Dresdner, Jr. et al. (U.S. Pat. Nos. 5,357,636, 5,335,373) utilized the capacity of polymeric laminates to enclose antiseptic compounds by designing gloves, of at least three layers (the middle layer containing the antiseptic). In other developments, utilizing an antimicrobial included within a polymeric, LeVeen et al (U.S. Pat. No. 4,381,380) used thermoplastic polyurethane treated with iodine as an bactericide; Fox Jr. et al (U.S. Pat. No. 5,019,096) used silver salt and chlorhexidine (or salts) to act as the antimicrobial agents; and, Shlenker et al (U.S. Pat. No. 5,128,168) incorporated a biocide into a latex membrane by dipping the latex into a biocide or by spraying the biocide onto a gelled latex. The universal cover can be made with such antimicrobial polymerics to help prevent pathogen transmission.

Chemical barriers in the polymeric can also be part of the polymeric in a universal cover. Busnel et al. (U.S. Pat. Nos. 4,930,522, 5,024,852) sought to reduce pathogen transference through the development of a “prophylactic device comprising at least two layers of elastomeric material arranged one on tope of the other having disposed there between microcapsules formed of rupturable walls having enclosed therein at least one pharmacologically active substance.” They proposed their material to be used in the following: “a contraceptive sheath, finger stall or glove.” Shlenker (U.S. Pat. Nos. 4,935,260, 5,045,341, 5,130,159) also incorporated a chemical barrier with a polymeric barrier; he indicated that “if an object cuts through the covering and into the person's skin or if a harmful agent tries to traverse through the covering, the chemical barrier will neutralize the harmful characteristics of the harmful agent so that the agent is neutralized either before or reaching the person's skin, after reaching the person's skin, or both.” Likewise, the polymeric in the universal cover can be designed to help neutralize pathogens.

A critical factor in each of these inventions was not simply the inclusion of a therapeutic and/or antimicrobial compound, but the simple fact that an impermeable barrier is also an effective means to reducing pathogen transmission. The question exists, how can one apply such a barrier, a cover, to a wide variety of situations, at a low cost, high effectiveness, without compromising the functionality of whatever it is applied to? The universal cover can economically utilize therapeutic and/or antimicrobial compounds, while also serving as an impermeable barrier, without compromising the functionality of whatever it is applied to.

### Covers to Prevent Spread of Pathogens—Example One—Telephones and Pagers

The universal cover can be used to cover instruments and equipment designed to transmit sound without interfering with the sound quality. A number of covers have been designed to reduce transmission of pathogens from person to person coming into contact with a common surface, while not interfering with sound transmission. In 1976, Efaw (U.S. Pat. No. 3,962,555) designed a handset guard to cover “both the mouthpiece and the receiver as well as a portion of the handle. The guard prevents the spread of germs both to and from the receiver and the mouthpiece of the telephone. Additionally, the guard is capable to some extent of preventing dirt, grease or undesirable substances from being transferred either to or from the handset of a telephone.” In U.S. Pat. No. 4,546,217, Frehn developed an invention that comprised of “a sleeve-like member adapted to receive and retain therein a telephone handset, and wherein a cord-encasing member is also provided to encase a telephone cord.” In U.S. Pat. No. 4,570,038, Tinelli developed a “sanitary cover for telephones and the like”; it was invented to prevent “transfer of bacteria or the like from the telephone to the user.” It was held in place by “an annular flange for slip-fit engagement with the sound transmitting portion of the telephone.” Another patent (U.S. Pat. No. 4,819,264) was an invention existed of a “soft foam pad treated with a disinfectant . . . ” which was secured to the phone via an adhesive backing. Lo et al (U.S. Pat. No. 5,054,063) addressed the problem of attaching a cover to the cover, consisting of a disposable sheet, by the use of an adhesive. The use of an adhesive to hold the covering in place was also part of the invention by Mitchell (U.S. Pat. No. 2000); he developed “a protective covering for a communications device” that “includes a resilient water-impermeable bag which is of one piece. The bag has a single opening through which the communications device can be inserted in the bag and a layer of adhesive runs around the opening on the inside of the bag.” Since telephones, pagers, and other communications devices are constantly changing, especially cellular phones, the very design of phones and other communications devices have changed considerably, even though the threat of pathogen transmission remains great. As such, covers which are adaptable to a wide variety of phone shapes are desirable. The universal cover can be made in a wide variety of shapes, making it amenable to a wide variety of instruments and equipments.

The universal cover can protect sound transmitting devises while reducing pathogen transmission. The problem of reducing pathogen transmission was also the focus of the patent by Elias et al (U.S. Pat. No. 4,781,323). They invented a “reclosable closure assembly for containers, particularly asceptic containers, containers having such a closure assembly, and a method for applying the closure assembly to preformed blanks suitable for preparing the containers.” The method of attaching the cover to the container was by the use of tapes. An exterior tape would be attached to a target tape, thus securing the cover to the container. Tape can be used with a universal cover, though by its very design the metallic foil—polymeric film laminate serves to secure the cover in place.

### Covers to Prevent Spread of Pathogens—Example Two—Stethoscopes

The universal cover has utility in clinical settings, such as in covering the head of a stethoscope. As such, one approach to addressing the utility of covers in a clinical setting is to discuss their use on an extremely commonly used clinical instrument—the stethoscope. An early attempt to use a polymeric film, in reference to stethoscope heads, was patented by Taylor et al. (U.S. Pat. No. 4,401,125). They devised “a pad for securing the head of a stethoscope to a patient's skin comprising, a generally annular sheet of flexible material larger than the head and having an outer edge, an inner edge defining an opening smaller than the head of the stethoscope, a slot extending from the outer edge to the inner edge, a back surface, a front surface, and an adhesive on the front surface of the sheet.” Plourde (U.S. Pat. No. 4,461,368) invented a diaphragm cover for a stethoscope which utilized a disposable or resterilizable membrane which would be affixed to the stethoscope head by the use of one or two tabs. Wright (U.S. Pat. No. 4,867,265) also developed a “cover for a pre-cordial stethoscope.” His invention differed from the previous one by Taylor et al in that his “cover fits closely on the stethoscope body and includes a slot for receiving a tubular fitting which extends from the stethoscope body to transmit the monitored sounds.” He also had “different embodiments of the cover . . . provided for adult and infant pre-cordial stethoscopes.” Ulert (U.S. Pat. No. 4,867,268) utilzed a different approach to reducing pathogen spread through stethoscope use. His invention had a “modified stethoscope head or diaphragm-retaining ring and a quick-insert/quick-release replaceable diaphragm. The diaphragm is suitably held in place on the stethoscope by means of a projection on the diaphragm surface which fits into a groove on the stethoscope or diaphragm-retaining ring.” Turner (U.S. Pat. No. 4,871,046) used an even different approach to making a suitable cover (shield). He invented a “shield or envelope . . . formed from a single piece of plastic material in which the sides are folded toward each other, thereby defining two top portions overlying a bottom portion.” A molded latex cover was also introduced by Mandiberg (U.S. Pat. No. 5,428,193). His invention involved a cover of one piece construction that fit “snugly over the tapered wall of the diaphragm portion.” In another deviation of the molded cover for stethoscopes, Appavu (U.S. Pat. No. 6,019,187) used an annulus which encircled the outer edge of a stethoscope head to hold the cover in place. The prior inventions use an annulus, or preformed ring, in the cover, but the universal cover has no preformed annulus, per se, but the external laminate ring is deformed to form the cover in place and, as such, represents an entirely new approach to holding a stethoscope cover in place.

The universal cover can be disposable. Kendall et al (U.S. Pat. No. 5,269,314) used another approach to reducing “transmission of contagious diseases between successive patients examined with the same stethoscope; they developed a disposable fabric cover with an elasticized outer hem as a single use cover for stethoscope heads. Lawton (U.S. Pat. No. 5,365,023) also utilized an elastomeric stethoscope cover; his invention was made from “latex or other material that is sufficiently elastomeric to allow the cover to be stretched over the stethoscope head during installation, and yet snap back to remain taunt after installation and during use of the stethoscope. The outer edge of the disk is preferably rolled, and the disk is preferably pre-shaped in a shallow parabola, to further ease installation and removal.” Weckerie et al (U.S. Pat. No. 5,747,751) also used a stretchable material, which they claimed to be “essentially universal and accommodates most stethoscope style heads as currently used. Moreover, they indicated that “variations of the cover relate to the shape of the cover and to the manner in which the open end is form.” Even another patent (U.S. Pat. No. 5,921,941) utilized a disc-shaped cover made from elastomeric material; a raised dimple incorporated into the cover “for being grasped and pulled away from the stethoscope when the removal of the cover from the stethoscope is desired. The cover may include perforations or some other form of weakness area which tear the cover to facilitate removal when desired.” Skubal et al (U.S. Pat. No. 6,006,856) also utilized a cover made from an elastic sheath; however, they added a retaining ring to their invention. The universal cover is different in that its holding capacity does not depend upon an elastic material, but on a deformable metallic foil polymeric film laminate.

The universal cover, while not depending upon elastic materials to hold it in place, it also does not depend upon being molded in a precise fit to the stethoscope head. In contrast to using an elastameric material for his inventions, Wurzburger (U.S. Pat. Nos. 5,424,495, 5,528,004, 5,686,706, 5,949,032) invented “a dispensable, disposable shield for stethoscopes” which prevented “the transfer of disease or other contaminants through the incorporation of a disc of plastic film material having a defined edge surface, a pull-tab along the edge surface of the disc, and an adhesive backing on the plastic film material disc, with the plastic film material having a contour for covering a diaphragm of the stethoscope and with the adhesive backing covering the entire contour of the disc and being peelably detachable from the stethoscope diaphragm after use. In a second embodiment, the pull-tab is replaced by a flap;” the use of flaps to hold the cover in place was a fundamental feature of the cover developed by Milam (U.S. Pat. No. 6,186,957) However, the use of adhesives remains the most common approach to attaching a cover to a stethoscope. Adhesive was also utilized by Stark et al (U.S. Pat. No. 544,025) to “secure the cover to the outer rim surface of a stethoscope head”, by Budayr et al. (U.S. Pat. No. 5,587,561), by Weidman et al. (U.S. Pat. No. 6,009,971), and Stark et al. (U.S. Pat. No. 6,206,134). While adhesives are not necessarily needed with the universal cover, their use is not prohibited by the invention.

Just as with containers with specifically shaped rims, the universal cover does not depend on the use of hooks or loops to hold it in place. Another approach to attaching stethoscope covers was developed by Eddy (U.S. Pat. No. 5,592,946). “The cover has hook-and-loop or alternatively snap fasteners for releasably closing the cover, in order to affix the cover to the stethoscope.” In contrast, Earnest (U.S. Pat. No. 5,623,131) developed a “protective stethoscope cover having a head cover connected to a body cover” by the use of a cover flap. Even another approach to attaching such covers was developed by Knight et al. (U.S. Pat. No. 5,808,244). They devised a protective cover for a stethoscope's contact surface that held in place by a static charge. The universal cover holds the protective cover in place without dependence upon snaps, hooks, loops, or simple static charge.

The universal cover lends itself to being dispensed. Ross et al (U.S. Pat. No. 5,466,897) also addressed the problem of covering stethoscope heads to prevent spread of infection. They developed a dispenser by which covers could be removed “from a stack, and” presented “for attachment to a stethoscope, when dispensing plate is shuttled between retracted and extended positions.” Seward (U.S. Pat. No. 5,564,431) also developed a “flexible stethoscope cover, cover package and dispensing system.” She indicated her “inventive device includes a pair of circular webs joined together by a side wall web. The webs are formed of a resilient material and are stored in a rolled condition, whereby the device can be installed to the stethoscope head by unrolling the cover over the head. The inventive device also includes a disposable package for containing the cover, as well as a container for its disposal. In contrast to covers in a rolled condition for dispensing, Weidman et al. (U.S. Pat. No. 6,009,971) indicated that their covers would be stacked upon each other. The universal cover can also be dispensed in rolls or in a stacked manner.

The diaphragm of the universal cover serves as a barrier against pathogen transmission. All of the inventions patented to cover stethoscope heads relied upon simple barrier properties to separate the source of infection with the possible target (as in the complete cover—or bags—for a stethoscope in U.S. Pat. Nos. 5,466,898, 5,486,659). All of them relied upon some form of preforming of the cover, thus becoming obsolete if the stethoscope head changes. However, stethoscopes themselves have evolved with improved technology, with that change stethoscope heads which had been universally round take on other shapes. Simple stethoscopes relying solely upon conduction of sound through a diaphragm, then the tubing, and finally the earpieces, have been transcended by the development of digital stethoscopes. Thus, covers which depend upon specific sizes of the head, use of adhesives to be attached to the instrument (unlikely with the expense of the more technologically advanced stethoscopes), and slots in the instrument, are not suitable for the widespread variation currently on the market. A universal cover which can be used on stethoscopes would be desirable. Just as importantly, because the cover would be universal, it could be readily adapted to nonstethoseope uses within a clinical setting (e.g., the covering of containers); thus, the universal cover would be more cost effective than a single utility item (stethoscope cover only).

### Covers to Prevent Spread of Pathogens—Example Three—Sphygmomanometer (Blood Pressure Cuff)

The universal cover can also be used with sphygmomanometer. The transference of pathogens from one person to another may also occur when a sphygmomanometer (blood pressure cuff) is used from one person, who has an infectious skin ailment, to another person who has not been infected. Although many items may be one use (e.g., blood pressure cuffs), such tends to become expensive. As a result, Byrd (U.S. Pat. Nos. 5,228,448, 5,620,001) developed a protective cover for blood-pressure cuffs. He indicated that his invention consisted of “a protective cover for covering a blood pressure cuff” comprising of “a flexible sheet defining an elongated band, an elongated top band, and an intermediate portion interconnecting the bottom and top bands. . . . The sheet is two-ply, having an exterior layer of soft absorbent material and an interior layer of more liquid impervious material. . . . The bottom band includes an attachment device for attaching opposite end portions of the bottom band . . . the top band includes an attachment device for attaching opposite end portions of the top band together.” The universal cover, as represented in this patent, would also be adaptable to serve as a cover for blood pressure cuffs. In such a use, the universal cover would light weight, be easy to apply, not interfere with the obtaining of blood pressure readings, easy to remove, serve as a barrier against pathogen transference from patient to patient, be temporary, be disposable, and be inexpensive.

### Covers Used to Cover Wounds

The universal cover can also made with an absorbent diaphragm, as would be needed for covering of wounds. Covers using polymeric films, enclosing an absorbent material, have been used in the development of wound dressings (also a form of cover) to help control and contain leakage of fluid from a wound (U.S. Pat. Nos. 5,090,406, 5,106,362, 5,465,735). As with polymerics which incorporate antibiotic materials in them, multilayer laminate wound dressings can also include antibacterial, antifungal and analgesic properties (U.S. Pat. No. 6,087,549). Normally, such covers are held in place by the use of an adhesive, either as part of the cover itself or added by the person applying the dressing. The use of would dressings which can be self forming, by the use of a deformable rim, has not been the subject of invention. As a result, the universal cover, as in this invention, would be useful in such situations.

### Covers to Prevent Contamination of Firearm Barrels

The universal cover also has the benefit that it can be used to cover the end of a firearm barrel to prevent contaminants from entering therein. The introduction of mud, dirt, or other contaminants into the barrel of a firearm has always been of concern to those who use firearms. If such contaminants pollute the barrel, it may explode upon firing, not only rendering the firearm useless, but may also cause serious injury, even death, to the shooter. During the Gulf War, because of the danger of contaminated barrels of firearms, soldiers used condoms over the muzzles of their weapons. Condoms, however, are not small, particularly when affixed to the barrel of a modern rifle. After the gulf war, Baer Sr. (U.S. Pat. No. 6,345,463) designed an “extended dust cover for a handgun.” It covered the muzzle, but was not developed for protecting firearms in field operations. The capability to cover the muzzle of a firearm is an asset encompassed by the universal cover.

Because care must be taken that the barrel cover itself does not constitute a hazard to the user of the firearm, such covers (as the current invention—the universal cover), unfortunately, have not been developed. The cover would have to be relatively loose fitting (to allow gaseous exchange), snug enough to prevent contamination of the barrel, have a membrane over the muzzle which would not hinder the bullet's travel, be easy to apply and remove, inexpensive, and disposable. As a result, the universal cover, as in this invention, would be useful in such situations (the protection of a firearm barrel against contamination).

### Covers to Prevent Contamination of Pipes and Tubing

This invention, the universal cover, can be used with pipes and tubing. A major problem when laying pipes and tubing, as in an irrigation system, is that soil can enter the pipe. This fouling of the pipe can be difficult to remove and later affect the performance of the system (as with the fouling of a sprinkler jet or of a drip system), possibly leading to failure of the system. A cover over a pipes open end during installation, which would be easy to apply and remove, inexpensive, and disposable would help rectify this problem. As a result, the universal cover, as in this invention, would be useful in such situations in which tubing or pipe ends must be covered.

### Covers to Temporarily Protect Containers of Paints, Spackle, or Similar Materials

Currently, when a person uses paints, sealants, spackles (and wall repair materials), glues, or any number of household or other building materials, the container must be repeatedly sealed during use. A temporary cover, which can be easily applied and removed, disposable, serving as a barrier to outside contamination (e.g., dirt), and acting as a barrier to gaseous and vapor exchange, has not been developed. As a result, the universal cover, as in this invention, would be useful in such situations in which the user wants to temporarily cover a container containing paints, spackle, or many other materials.

### Covers in a Laboratory or Clinical Glassware

Temporary covers for containers, surfaces, and other equipment are often fabricated on the spot in laboratories, either to reduce loss of materials or to prevent contamination from the environment; but, few are as amenable to use as the universal cover. Currently, persons working in a laboratory or clinical setting have the options of purchasing parafilm, polyethylene film, saran film, or aluminum foil to make covers for their glassware, equipment, or instruments. The choice is often left to the individual utilizing the laboratory gear, according to that which is available and according to the material being covered, stored, or contained. Unfortunately the choices are often limited. Also., the use of parafilm, a commonly used laboratory material to make temporary covers, can leave a ring of parafilm around the opening of the glassware, which at times can be difficult to remove. An invention which incorporates the benefits of deformability of a metallic foil with a polymeric membrane has yet to be introduced; as a result, the universal cover, as in this invention, would be useful in such situations.

### Covers in Household and Commercial Settings

The universal cover is also amenable for use in household and commercial use. The reduction of contamination of foods is also important both in homes and in many commercial establishments. Yet, just as in the clinical and laboratory setting, a person desiring to purchase a sheet to serve as a seal or cover is often left with the choices of aluminum foil, saran wrap, or polyethylene film; for to avail of other options one may have to obtain such foils, wraps, films, and/or laminates from a specialty source. While the products most available are indeed useful, the aluminum foil, while it keeps its shape, does not cling like the polymeric films, neither is it transparent. The polymeric films do not have the deformability and the strength of the aluminum foil. By using the metallic foil at the edges of the cover, one obtains benefits of strength around the perimeter of the cover, conformity to the shape of the item so covered, and ease in application and removal of the cover. By having the inner membrane made of polymeric film, one can obtain the benefits of transparency along with all the other benefits discussed earlier about polymeric films; as a result, the universal cover, as in this invention, would be useful in such situations.

Thus, there is a great need for a universal cover that is inexpensive, lightweight, effective, quickly and easily attached (and detached), prevents or minimizes contamination (by acting as a barrier), does not itself contaminate the contents being covered, and/or does not interfere with the utilization of an instrument (when used to prevent crosson, contamination, e.g., as with stethoscopes).

### Prior Art References Related to Invention (as per IDS/PTO-1449): None

### U.S. Patent Documents Cited in Background of Invention

| | | | |
|---|---|---|---|
| 3931449 | January 1976 | Hirata et al. | 428/339. |
| 3932692 | January 1976 | Hirata et al. | 428/35.7. |
| 3932693 | January 1976 | Shaw et al. | 428/518. |
| 3949114 | April 1976 | Viola et al. | 428/337. |
| 3962555 | June 1976 | Efaw | 379/419. |
| 3997703 | December 1976 | Nakashio et al. | 428/457. |
| 4003963 | January 1977 | Creasy et al. | 525/57. |
| 4055698 | October 1977 | Beery | 428/346. |
| 4064296 | December 1977 | Bornstein et al. | 428/34.9. |
| 4082854 | April 1978 | Yamada et al. | 426/106. |
| 4096309 | June 1978 | Stillman | 442/382. |
| 4194039 | March 1980 | Mueller | 428/213. |
| 4239826 | December 1980 | Knott, II et al. | 428/36.7. |
| 4240993 | December 1980 | Sun | 264/456. |
| 5254169 | March 1981 | Schroeder | 428/36.6. |
| 4355721 | October 1982 | Knott II et al. | 206/524.2. |
| 4381380 | April 1983 | LeVeen et al. | 525/452. |
| 4401125 | August 1983 | Taylor, et al. | 600/528. |
| 4461368 | July 1984 | Plourde | 181/131. |
| 4546217 | October 1985 | Frehn | 379/452. |
| 4568580 | February 1986 | Ghiradello et al. | 428/34.9. |
| 4570038 | February 1986 | Tinelli | 4570038. |
| 4578294 | March 1986 | Ouchi et al. | 428/220. |
| 4612221 | September 1986 | Biel et al. | 428/35.4. |
| 4617241 | October 1986 | Mueller | 428/520. |
| 4675347 | June 1987 | Mochizuki et al. | 523/122. |
| 4769013 | September 1988 | Lorenz et al. | 604/265. |
| 4781323 | November 1988 | Elias et al. | 229/123.3. |
| 4801486 | January 1989 | Quacquarella, et al. | 428/34.9. |
| 4819264 | April 1989 | Lemley | 379/452. |
| 4847050 | July 1989 | Jenkins et al. | 422/102. |
| 4853978 | August 1989 | Stockum | 2/167. |
| 4867265 | September 1989 | Wright | 181/131. |
| 4867268 | September 1989 | Ulert | 181/137. |
| 4867968 | September 1989 | Allen | 514/39. |
| 4871046 | October 1989 | Turner | 181/131. |
| 4881277 | November 1989 | Hogle | 2/169. |
| 4901372 | February 1990 | Pierce | 2/167. |
| 4930522 | June 1990 | Busnel et al. | 128/844. |
| 4935260 | June 1990 | Shlenker | 604/349. |
| 4959271 | September 1990 | Sun | 428/476.3. |
| 4977004 | December 1990 | Beetle III et al. | 428/36.7. |
| 4977022 | December 1990 | Mueller | 428/349. |
| 5024852 | June 1991 | Busnel et al. | 427/2.3. |
| 5031245 | July 1991 | Milner | 2/168. |
| 5045341 | September 1991 | Shlenker | 128/844. |
| 5054063 | October 1991 | Lo et al. | 379/452. |
| 5090406 | February 1992 | Gilman | 602/47. |
| 5019096 | May 1991 | Fox, Jr., et al. | 600/36. |
| 5106362 | April 1992 | Gilman | 602/47. |
| 5119940 | June 1992 | Grindrod | 426/120. |
| 5130159 | July 1992 | Shlenker | 427/2.3. |
| 5228448 | July 1993 | Byrd | 600/490. |
| 5256428 | October 1993 | Lustig et al. | 426/127. |
| 5269314 | December 1993 | Kendall et al. | 600/528. |
| 5310587 | May 1994 | Akahori et al. | 428/35.2. |
| 5335373 | August 1994 | Dresdner, Jr. et al. | 2/161.7. |
| 5357636 | October 1994 | Dresdner, Jr. et al. | 2/161.7. |
| 5365023 | November 1994 | Lawton | 181/131. |
| 5397613 | March 1995 | Georgelos | 428/36.7. |
| 5405629 | April 1995 | Marnocha et al. | 426/122. |
| 5424495 | June 1995 | Wurzburger | 181/131. |
| 5428193 | June 1995 | Mandiberg | 181/131. |
| 5439132 | August 1995 | Gorlich | 220/257.1. |
| 5448025 | September 1995 | Stark et al. | 181/131. |
| 5465735 | November 1995 | Patel | 128/888. |
| 5466897 | November 1995 | Ross et al. | 181/131. |
| 5466898 | November 1995 | Gilbert et al. | 181/131. |
| 5486659 | January 1996 | Rosenbush | 181/131. |
| 5528004 | June 1996 | Wurzburger | 181/131. |
| 5535346 | July 1996 | Robinson | 428/343. |
| 5564431 | October 1996 | Seward | 600/528. |
| 5587561 | December 1996 | Budayr et al. | 181/131. |
| 5592946 | January 1997 | Eddy | 600/528. |
| 5620001 | April 1997 | Byrd et al. | 606/202. |
| 5623131 | April 1997 | Earnest | 181/131. |
| 5686706 | November 1997 | Wurzburger | 181/131. |
| 5707751 | January 1998 | Garza et al. | 428/515. |
| 5747751 | May 1998 | Weckerie et al. | 181/131. |
| 5779050 | July 1998 | Kocher et al. | 206/497. |
| 5808244 | September 1998 | Knight et al. | 181/131. |
| 5921941 | July 1999 | Longobardo et al. | 600/528. |
| 5949032 | September 1999 | Wurzburger | 181/131. |
| 6006856 | December 1999 | Skubal et al. | 181/131. |
| 6009971 | January 2000 | Weidman et al. | 181/131. |
| 6019187 | February 2000 | Appavu | 181/131. |
| 6082535 | July 2000 | Mitchell | 206/320. |
| 6087549 | July 2000 | Flick | 602/41. |
| 6089300 | July 2000 | Woodside et al. | 160/37. |
| 6171681 | January 2001 | Mascarenhas et al. | 428/141. |
| 6183791 | February 2001 | Williams et al. | 426/129. |
| 6186957 | February 2001 | Milam | 600/528. |
| 6206134 | March 2001 | Stark et al. | 181/131. |
| 6345463 | February 2002 | Baer, Sr. | 42/97. |
| 6432253 | August 2002 | Chung | 156/295. |

### BACKGROUND OF INVENTION—OBJECTS AND ADVANTAGES

Accordingly, besides the objects and advantages of the previously developed covers, metallic foils, and polymeric films, described in my above patent, several objects and advantages of the present patent application of James Lowell Jordan for the “Universal Cover” invention are:

(a) to provide a cover which can be produced in a variety of colors and materials without requiring the manufacture to develop materials that are not already currently and commonly used;

(b) to provide a universal cover which may be used to provide a spill-resistant cover for containers holding solids, gels, suspensions, or liquids;

(c) to provide a covering whose production can be done in continuous rolls, from which the actual coverings may be extracted singularly, as sheets, or as rolls, by the use of either a cutting implement or perforations;

(d) to provide a covering that can be packaged individually, when sterility is desired, or in stacks;

(e) to provide a covering whose inner membrane and external metallic foil/polymeric film laminate can be readily adapted not only by size, but also according to the item being covered;

(f) to provide a covering that serves as an effective barrier that can be either be reused or disposed of, as the situation requires;

(g) to provide a covering that is not only easy to apply, but also easy to remove;

(h) to provide a covering that may be made in an infinite number of shapes and patterns, including, but not limited to, oval, circular, rectangular, triangular, square, pentagonal, hexagonal, and continuous sheet;

(i) to provide a cover which can be constructed from absorbent material so that, when used as a cover, it can be used as a wound dressing and/or absorbent pad whose structure and placement are maintained by the deformabiltiy of the outer metallic rim (rims);

(g) to provide a cover which can also be used as a wrap; in that the rim (edges) of the unit are deformable, items may be placed upon the film and the outer edges twisted to form a seal around the object.

### BRIEF SUMMARY OF THE INVENTION

In accordance with the present invention a cover comprising of a polymeric membrane with an external metallic foil—polymeric film laminate, in which the metallic foil serves to secure the polymeric membrane in place and the polymeric membrane serves to act as the barrier.

It is another object of the present invention to provide a cover which minimizes or eliminates contamination—either of contents covered or from the contents being covered.

It is another object of the present invention to provide an effective cover to reduce or eliminate pathogen transference among patients when used in a clinical setting.

It is another object of the present invention to increase safety and utility of objects being covered, as in the cases of covering firearm muzzles, pipes, and containers.

The above, and other objects of the present invention are achieved, in a preferred embodiment of the present invention, by providing a universal cover which incorporates the beneficial components of polymeric films with those of metallic foils. The internal diaphragm itself being composed of the polymeric film and the external rim being composed of a metallic foil affixed to the polymeric film to form a laminate. The metallic foil is deformable and holds the cover in place. The preferred embodiments of the present invention utilize a flat polymeric film, in sheet-form, to form a membrane having a uniform thickness—the thickness being dependent upon the polymeric material being used and the intended surface or opening to be covered by the cover. Since surfaces and openings come in a wide variety of sizes, the size of the cover itself, the internal diaphragm, and the external rim also vary accordingly. Thus, the universal cover can be made small enough to cover surfaces and openings of only a few millimeters in size, while another universal cover may be made large enough to cover one of several meters in size.

### DRAWINGS—FIGURES

The above, and other embodiments of the present invention, may be more fully understood from the detailed description taken together with the accompanying drawings illustrating examples wherein similar reference characters refer to similar elements in which:

FIG. 1 illustrates a round universal cover with the metallic foil rim-polymeric film laminate edge completely encircling the polymeric diaphragm interior;

FIG. 2 illustrates a universal cover with the metallic foil-polymeric film laminate on two edges only;

FIG. 3 illustrates the cross section of a laminate edge consisting of one metallic foil layer and one polymeric film layer;

FIG. 4 illustrates the cross section of a laminate edge consisting of two metallic foil layers sandwiching a polymeric film layer.

### DRAWINGS—REFERENCE NUMERALS

1 Polymeric film

2 Metallic foil-Polymeric film laminate

3 Metallic foil

### DESCRIPTION OF THE PREFERRED EMBODIMENTS

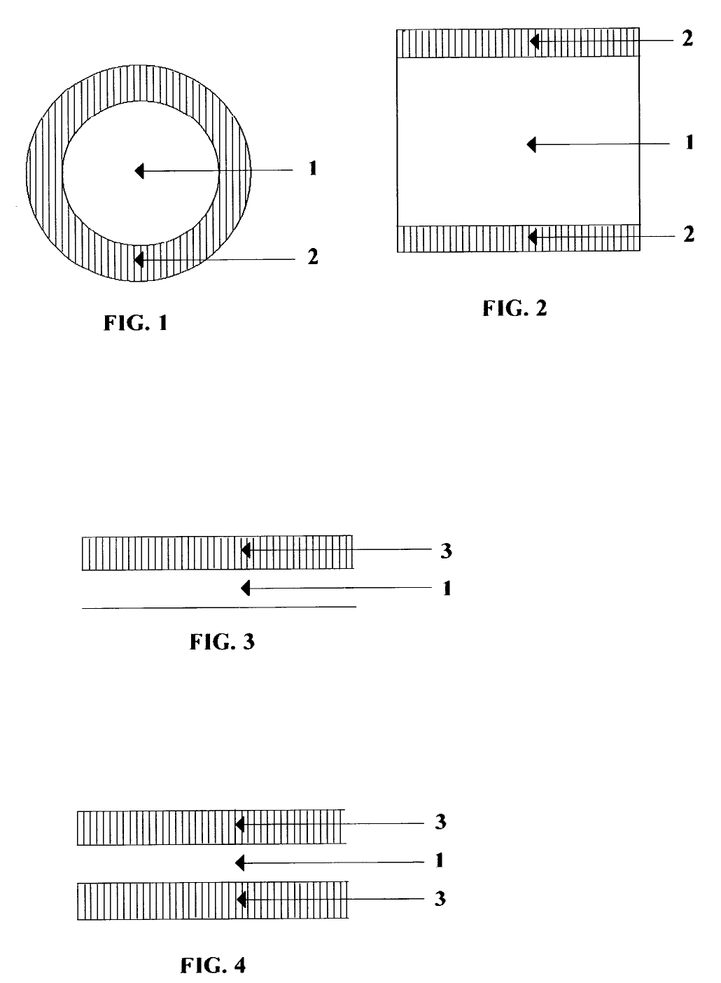

Referring now to the Drawings, there is shown in FIG. 1 a universal a round universal ver with the metallic foil rim-polymeric film laminate edge completely encircling the lymeric film diaphragm. The universal cover with a laminate edge completely circling the polymeric film diaphragm would be suitable as a cover for stethoscopes, rearm muzzles, containers, tubing, surfaces, and piping. A universal cover with the metallic foil-polymeric film laminate on two edges only is shown in FIG. 2. The universal cover illustrated in FIG. 2 may be used as a cover for sphygmomanometers, containers, tubing, piping, and surfaces. The universal covers shown in FIGS. 1 and 2 can be used to wrap materials. The laminate edge, composed of a single layer each of metallic foil and polymeric film, is shown in FIG. 3. The laminate edge, composed of layers of metallic foil sandwiching a polymeric film layer between them, is shown in FIG. 4.

The metallic foil and polymeric material of the universal covers shown in FIGS. 1 to 4 are affixed to each other by heat, pressure and/or adhesive.

The polymeric material, in FIGS. 1 to 4, can be successfully constructed from a number of materials including latex rubber, cis-1,4-polyiosprene, cis-polybutadiene, neoprene rubber, nitrile rubber, silicone rubber and mixtures thereof, cellulose acetate plastic, vinyl plastic, polyethylene plastic, polypropylene plastic, polyvinyl chloride plastic, polyvinyl acetate plastic, polystyrene plastic, polymethyl methyl-acrylate plastic, polyacrylonitrile plastic, vinyllite plastic, saran plastic, polytetrafluoroethylene plastic, polytrifluorochloroethylene plastic, polycaprolactam plastic, polyester plastic, urea formaldehyde plastic, polyurethane plastic, isotactic polypylene plastic, nylon plastic, rayon plastic, polyamide plastic, phenolic plastic, silicone plastic, silk fiber, cotton fiber, cellulose fiber, wool fiber, animal skin, animal intestinal tissue, animal connective tissue, metallic fiber, mineral fiber, metallic-polymeric combinations designed to reduce static electricity, compositions incorporating agents with regard to antimicrobial activity, any manmade material, any plant material, any animal material, and mixtures thereof.

The metallic foil, in FIGS. 1 to 4, that may be used in this invention include aluminum, aluminum alloys, copper, copper alloys, iron, iron alloys, zinc, zinc alloys, lithium, lithium alloys, lithium, lithium alloys, tin, tin alloys, nickel, nickel alloys, molybdenum, molybdenum alloys, manganese, manganese alloys, titanium, titanium alloys, carbon or silicon compounds that are used to replace metals, and any mixtures and alloys thereof. When the polymeric diaphragm is thicker, the metallic foil in the rim must be correspondingly thicker and/or wider to hold the cover in place. When the polymeric film interior is lighter and thinner, a correspondingly thinner and/or narrower rim may be used, universal cover of different shapes, both overall and in terms of the internal diaphragm.

Having described my invention I claim:

1. A cover comprising:
(a) a metallic foil-polymeric film laminate rim containing one layer or more layers of metallic foil;
(b) an internal polymeric film diaphragm.

2. The universal cover of claim 1 wherein layers of the outside rim are affixed to each other by heat, pressure, adhesive or any combination of heat, pressure, or adhesive.

3. Any of the following may be used as the “polymeric” film in this invention, as per claim 1: latex rubber, cis-1,4-polyiosprene, cis-polybutadiene, neoprene rubber, nitrile rubber, silicone rubber and mixtures thereof, cellulose acetate plastic, vinyl plastic, polyethylene plastic, polypropylene plastic, polyvinyl chloride plastic, polyvinyl acetate plastic, polystyrene plastic, polymethyl methyl-acrylate plastic, polyacrylonitrile plastic, vinyllite plastic, Saran plastic, polytetrafluoroethylene plastic, polytrifluorochloroethylene plastic, polycaprolactam plastic, polyester plastic, urea formaldehyde plastic, polyurethane
